(19) United States
(12) Patent Application Publication
(10) Pub. No.: US 2020/0312340 A1
(43) Pub. Date: Oct. 1, 2020

(54) AUDIO SIGNAL CHAIN IDENTIFICATION

(71) Applicant: HCL AMERICA, INC., Sunnyvale, CA (US)

(72) Inventor: MICHAEL JAMES HUDSON, BOCA RATON, FL (US)

(21) Appl. No.: 16/370,289

(22) Filed: Mar. 29, 2019

(51) Int. Cl. G10L 19/018; G10L 19/02; G06F 16/683

(52) U.S. Cl. CPC G10L 19/018; G06F 16/683; G10L 19/02

(57) ABSTRACT

Disclosed is a system for facilitating identification of a sound generation device used for creating an audio clip. The audio clip is created by combining one or more audio signal chains corresponding to at least one sound generation device. Each audio signal chain is embedded with an audio signature having frequency beyond a frequency range of human hearing. The audio signature comprises a unique identification number corresponding to the sound generation device. The system upon receipt of the audio clip, identifies the audio signature associated with each audio signal chain from the one or more audio signal chains. Subsequently, the system analyses the audio signature to identify the sound generation device.

### PRIORITY INFORMATION

This patent application does not claim priority from any application.

### TECHNICAL FIELD

The present subject matter described herein, in general, relates to identifying a sound generation device and more particularly to identifying a sound generation device using an audio signature embedded in into an audio signal chain created from the sound generation device.

### BACKGROUND

Typically, every audio mix is a combination of one or more individual audio signal chains created from a plurality of sound generation device. Example of the sound generation device may include, but not limited to, a guitar, a synthesizer, a compressor, a drum machine, different plugins, and simulators. It has been observed that musicologists like nothing more than to debate about a particular sound generation device used in the audio mix. As the audio mix comprises an overlap of the one or more individual audio signal chains, it becomes cumbersome to identify each individual signal chain from the audio mix. In addition, the musicologists have to rely on limited photographic, video evidences, and word of mouth available (if any) to identify the sound generation device used in creation of the audio mix.

### SUMMARY

Before the present systems and methods for identifying a sound generation device, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and methods for identifying a sound generation device and the concepts are further described below in the detailed description. This summary is not intended to identify essential features of the claimed subject matter nor is it intended for use in determining or limiting the scope of the claimed subject matter.

In one implementation, a method for identifying a sound generation device is disclosed. In order to identify the sound generation device, initially, an audio clip may be received. Further, one or more audio signatures may be determined from the audio signal chain. Each audio signature from the one or more audio signal chains may correspond to at least one of a sound generation device. It may be noted that each audio signal chain may comprise an audio signature having a frequency beyond a predefined threshold range. Subsequently, the audio signature comprising a unique identification number may be identified. Furthermore, the audio signature may be decoded to obtain the unique identification number comprising a plurality of parameters. Upon decoding, the sound generation device may be identified by analyzing the plurality of parameters. In one aspect, the aforementioned method for identifying a sound generation device may be performed by a processor using programmed instructions stored in a memory.

In another implementation, a method for encoding an audio signature is disclosed. Initially, an audio signature from at least one of a sound generation device and a plurality of parameters about the at least one sound generation device may be received. Further, a unique identification number may be generated based on the plurality of parameters. Furthermore, the unique identification number may be converted into an audio signature having a frequency beyond a predefined threshold range. Subsequently, the audio signal may be encoded by embedding the audio signature into the audio signal chain. In one aspect, the aforementioned method for encoding an audio signal chain may be performed by a processor using programmed instructions stored in a memory.

In yet another implementation, a system for identifying a sound generation device is disclosed. The system may comprise a processor and a memory coupled to the processor. The processor may execute a set of instructions stored in the memory. Initially, the system may receive an audio clip. Further, the system may determine one or more audio signal chains from the audio clip. Each audio signal chain from the one or more audio signal chains may correspond to at least one of a sound generation device. It may be noted that each audio signal chain may comprise an audio signature having a frequency beyond a predefined threshold range. Subsequently, the system may identify the audio signature comprising a unique identification number. Furthermore, the system may decode the audio signature to obtain the unique identification number comprising a plurality of parameters. Upon decoding, the system may identify the sound generation device by analyzing the plurality of parameters.

In yet another implementation, a system for encoding an audio signal chain is disclosed. The system may comprise a processor and a memory coupled to the processor. The processor may execute a set of instructions stored in the memory. Initially, the system may receive an audio signal chain from at least one of a sound generation device and a plurality of parameters about the at least one sound generation device. Further, the system may generate a unique identification number based on the plurality of parameters. Furthermore, the system may convert the unique identification number into an audio signature having a frequency beyond a predefined threshold range. Subsequently, the system may encode the audio signal chain by embedding the audio signature into the audio signal chain.

In yet another implementation, non-transitory computer readable medium embodying a program executable in a computing device for identifying a sound generation device is disclosed. The program may comprise a program code for receiving an audio signal chain from at least one of a sound generation device and a plurality of parameters about the at least one sound generation device. Further, the program may comprise a program code for generating a unique identification number based on the plurality of parameters. The program may comprise a program code for converting the unique identification number into an audio signature having a frequency beyond a predefined threshold range. The program may comprise a program code for encoding the audio signal chain by embedding the audio signature into the audio signal chain. The program may comprise a program code for receiving an audio clip comprising one or more audio signal chains. The program may comprise a program code for determining the one or more audio signatures. It may be noted that each audio signature from the one or more audio signal chains may correspond to at least one sound generation device. The program may comprise a program code for identifying the audio signature comprising the unique identification number. The program may comprise a program code for decoding the audio signature to obtain the unique identification number comprising the plurality of parameters. The program may comprise a program code for identifying the sound generation device by analyzing the plurality of parameters.

### BRIEF DESCRIPTION OF THE DRAWINGS

The foregoing detailed description of embodiments is better understood when read in conjunction with the appended drawings. For the purpose of illustrating the disclosure, example constructions of the disclosure are shown in the present document; however, the disclosure is not limited to the specific methods and apparatus for identifying a sound generation device as disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates an implementation of a system for identifying a sound generation device, in accordance with an embodiment of the present subject matter.

FIG. 2a illustrates the system for identifying a sound generation device, in accordance with an embodiment of the present subject matter.

FIG. 2b illustrates the system for encoding an audio signal chain, in accordance with an embodiment of the present subject matter.

FIG. 3a illustrates a method for identifying a sound generation device, in accordance with an embodiment of the present subject matter.

FIG. 3b illustrates a method for encoding an audio signal chain, in accordance with an embodiment of the present subject matter.

### DETAILED DESCRIPTION

Some embodiments of this disclosure, illustrating all its features, will now be discussed in detail. The words “receiving,” “identifying,” “determining,” “encoding,” “decoding,” “converting,” “embedding”, and “analyzing” and other forms thereof, are intended to be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods for identifying a sound generation device are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The present invention indicates a system for identifying a sound generation device. In order to identify the sound generation device, initially, an audio clip comprising one or more audio signal chains must be uniquely encoded. It is understood that each audio signal chain is an output of at least one sound generation device. Thus, the one or more audio signal chains corresponds to one or more sound generation device. Hence, to identify the sound generation device, the system must also embed a unique signature of each sound generation device in the audio signal chain.

In order to encode the audio signature, the system may receive a plurality of parameters from the sound generation device. Example of the plurality of parameters include, but not limited to, manufacturer information, a device id, a device year, serial number, seller information, a timestamp, and an assembly location. The system may generate a unique identification number for each sound generation device based on the plurality of the parameters.

Further, the unique identification number may be converted into an audio signature having frequency beyond a frequency range of human hearing. It is to be noted that the audio signature beyond the frequency range of human hearing may only be listened by the system. The present system facilitates identification of the sound generation device by analyzing the audio signature corresponding to the sound generation device. In one implementation, the audio signature may enable verification of the sound generation device. While aspects of described system and method for identifying a sound generation device and may be implemented in any number of different computing systems, environments, and/or configurations, the embodiments are described in the context of the following exemplary system.

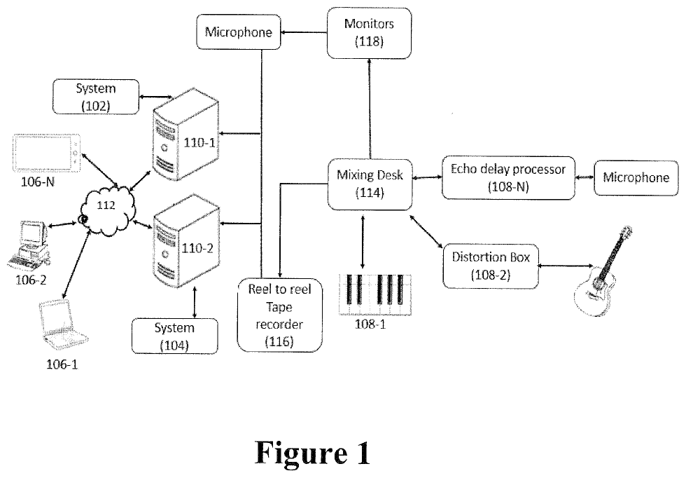

Referring now to FIG. 1, an implementation 100 of a system 102 is disclosed. In one implementation, the system 102 for identifying a sound generation device 108-1, 108-2 . . . 108-N, collectively referred to as the sound generation device 108 is disclosed. Initially, the system 102 may receive an audio clip from at least one of a reel to reel tape recorder 116, a microphone, a set of monitors 118, and a mixing desk 114. It may be noted that the mixing desk 114 is configured to combine individual audio signal. Further, the system 102 may determine one or more audio signature from the audio signal. Each audio signature from the one or more audio signal may correspond to at least one of a sound generation device 108. It may be noted that each audio signal may comprise an audio signature having a frequency beyond a predefined threshold range. Subsequently, the system 102 may identify the audio signature comprising a unique identification number. Furthermore, the system 102 may decode the audio signature to obtain the unique identification number comprising a plurality of parameters. Upon decoding, the system 102 may identify the sound generation device 108 by analyzing the plurality of parameters.

In another implementation, the system 104 for encoding an audio signature is disclosed. Initially, the system 104 may receive an audio signal from at least one of a sound generation device and a plurality of parameters about the at least one sound generation device 108. Further, the system 104 may generate a unique identification number based on the plurality of parameters. Furthermore, the system 104 may convert the unique identification number into an audio signature having a frequency beyond a predefined threshold range. Subsequently, the system 102 may encode the audio signal by embedding the audio signature into the audio signal.

Although the present disclosure is explained considering that the system 102 for identifying a sound generation device and encoding an audio signal is implemented on a server, it may be understood that the system 102 may be implemented in a variety of computing systems, such as a laptop computer, a desktop computer, a notebook, a workstation, a mainframe computer, a server, a network server, a cloud-based computing environment. It will be understood that the system 102 may be used by multiple users through one or more user devices 106-1, 106-2 . . . 106-N, collectively referred to as user 106 or stakeholders, hereinafter, or applications residing on the user devices 106 to identify a sound generation device and encode an audio signature. In one implementation, the system 102 may comprise the cloud-based computing environment in which a user may operate individual computing systems configured to execute remotely located applications. Examples of the user devices 106 may include, but are not limited to, a portable computer, a personal digital assistant, a handheld device, and a workstation. The user devices 106 are communicatively coupled to the system 102 through a network.

In one implementation, the network 112 may be a wireless network, a wired network or a combination thereof. The network 112 can be implemented as one of the different types of networks, such as intranet, local area network (LAN), wide area network (WAN), the internet, and the like. The network 112 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 112 may include a variety of network devices, including routers, bridges, servers, computing devices, storage devices, and the like.

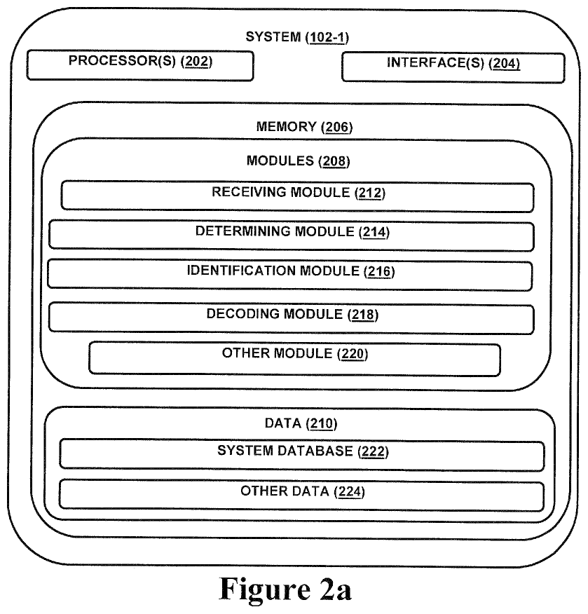

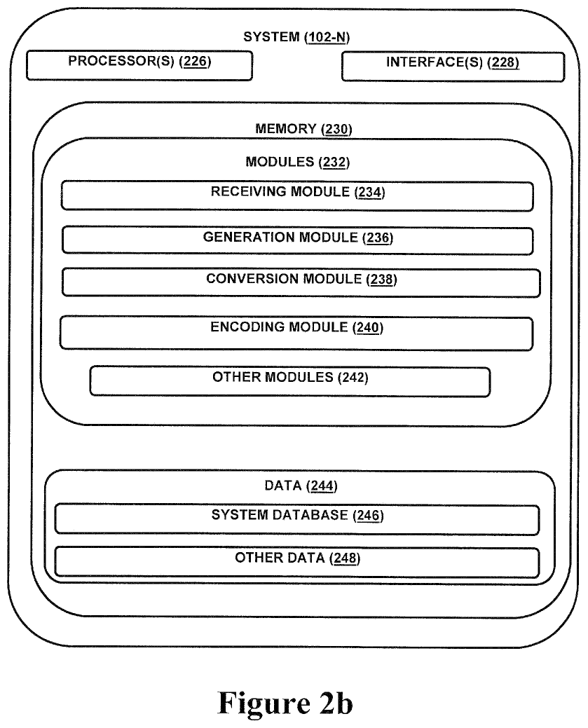

Referring now to FIG. 2a, the system 102 for identifying a sound generation device is illustrated in accordance with an embodiment of the present subject matter. In one embodiment, the system 102 may include at least one processor 202, an input/output (110) interface 204, and a memory 206. The at least one processor 202 may be implemented as one or more microprocessors, microcomputers, microcontrollers, digital signature processors, central processing units, state machines, logic circuitries, and/or any devices that manipulate signatures based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 for identifying a sound generation device to interact with the user directly or through the client devices 106. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a receiving module 212, a determining module 214, an identification module 216, a decoding module 218, and other modules 220. The other modules 220 may include programs or coded instructions that supplement applications and functions of the system 102 for identifying the sound generation device. The modules 208 described herein may be implemented as software modules that may be executed in the cloud-based computing environment of the system 102.

The data 210, amongst other things, serves as a repository for storing data processed, received, and generated by one or more of the modules 208. The data 210 may also include a system database 222 and other data 224. The other data 224 may include data generated as a result of the execution of one or more modules in the other modules 220.

As there are various challenges observed in the existing art, the challenges necessitate the need to build the system 102 for identifying the sound generation device. In order to identifying a sound generation device, at first, a user may use the client device 106 to access the system 102 via the I/O interface 204. The user may register them using the I/O interface 204 in order to use the system 102. In one aspect, the user may access the I/O interface 204 of the system 102. The system 102 may employ the receiving module 212, the determining module 214, the identification module 216, and the decoding module 218. The detail functioning of the modules is described below with the help of figures.

The present system 102 facilitates identification of the sound generation device from an audio clip. In order to identify the sound generation device, the receiving module 212 receives the audio clip. In one aspect, the audio clip may be received from the user devices 106. In another aspect, the audio clip may be received from at least one of a sound bar, a speaker, and a sound monitor. In one embodiment, the audio clip may be stored at the system database 222. It is to be noted that each audio clip is an overlap of one or more audio signal chains. Each audio signal chain may be associated to at least one sound generation device. Types of the sound generation may include, but not limited to, an acoustic device, an electronic device, and a hybrid device. In one example, the sound generation device may generate the audio signature in an analog format. In another example, the sound generation device may generate the audio signature in a digital format. In yet another example, the sound generation device may be connected to a digital signal processor for converting the analog format of the audio signal chain into the digital format.

The determining module 214 determines the one or more audio signatures from the audio clip. In order to identify the sound generation device, each audio signal chain may comprise one or more audio signatures having a frequency beyond a predefined threshold range. The predefined threshold range may be a range of frequencies audible to humans. Typically, the predefined threshold range may be between 20 Hz to 20 kHz. In one implementation, the audio signature may have a frequency more than 20 kHz. In one implementation, the audio signature may also be utilized to verify authenticity of the sound generation device. In one embodiment, the one or more audio signatures may be stored at the system database 222.

Subsequently, the identification module 216 identifies the audio signature comprising a unique identification number. It may be noted that the audio signature may be embedded into the audio signal chain for identification of the sound generation device. In one implementation, the identification module 216 may also convert the audio signature to the digital format when the audio signature is received in the analog format. Further, the decoding module 218 decodes the audio signature to obtain the unique identification number comprising a plurality of parameters. Example of the plurality of parameters comprises at least one of manufacturer information, a device id, a device year, a serial number, seller information, a timestamp, and an assembly location. Example of the unique identification number is “10CF34AXSA12345”. In one embodiment, the audio signature and the unique identification number may be stored at the system database 222.

Upon decoding the unique identification number, the identification module 216 identifies the sound generation device by analyzing the plurality of parameters. In order to elucidate further, consider an exemplary format of the unique identification number as “10CF34AXSA12345”. Upon decoding the unique identification number, the identification module 216 analyses the plurality of parameters associated to the “10CF34AXSA12345” to identify AID (Audio Identification) version as “10”, manufacturer as “CF”, model number as “34A”, checksum as “X”, model year as “S”, the assembly location of the sound generation device as “A”, and the serial number as “12345”. In one embodiment, the plurality of parameters corresponding to the sound generation device may be stored at the system database 222.

Referring now to FIG. 2b, the system 102 for encoding an audio signature is illustrated in accordance with an embodiment of the present subject matter. In one embodiment, the system 102 may include at least one processor 226, an input/output (I/O) interface 228, and a memory 230. The at least one processor 226 may be implemented as one or more microprocessors, microcomputers, microcontrollers, digital signature processors, central processing units, state machines, logic circuitries, and/or any devices that manipulate signatures based on operational instructions. Among other capabilities, the at least one processor 226 is configured to fetch and execute computer-readable instructions stored in the memory 230.

The I/O interface 228 may include a variety of software and hardware interfaces, for example, a web interface, a graphical user interface, and the like. The I/O interface 228 may allow the system 102 for encoding an audio signature to interact with the user directly or through the client devices 106. Further, the I/O interface 228 may enable the system 102 to communicate with other computing devices, such as web servers and external data servers (not shown). The I/O interface 228 can facilitate multiple communications within a wide variety of networks and protocol types, including wired networks, for example, LAN, cable, etc., and wireless networks, such as WLAN, cellular, or satellite. The I/O interface 228 may include one or more ports for connecting a number of devices to one another or to another server.

The memory 230 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 230 may include modules 232 and data 244.

The modules 232 include routines, programs, objects, components, data structures, etc., which perform particular tasks or implement particular abstract data types. In one implementation, the modules 232 may include a receiving module 234, a generation module 236, a conversion module 238, a generation module 240, and other modules 242. The other modules 242 may include programs or coded instructions that supplement applications and functions of the system 102 for encoding the audio signal chain. The modules 232 described herein may be implemented as software modules that may be executed in the cloud-based computing environment of the system 102.

The data 244, amongst other things, serves as a repository for storing data processed, received, and generated by one or more of the modules 232. The data 244 may also include a system database 246 and other data 248. The other data 248 may include data generated as a result of the execution of one or more modules in the other modules 242.

As there are various challenges observed in the existing art, the challenges necessitate the need to build the system 102 for encoding the audio signature. In order to encode the audio signature, at first, a user may use the client device 106 to access the system 102 via the I/O interface 228. The user may register them using the I/O interface 228 in order to use the system 102. In one aspect, the user may access the I/O interface 228 of the system 102. The system 102 may employ the receiving module 234, the generation module 236, the conversion module 238, and the generation module 240. The detail functioning of the modules is described below with the help of figures.

The present system 102 facilitates encoding an audio signature. It is to be noted that the audio signature is encoded to ensure authenticity and originality of the audio signal chain. The audio signature is an output of at least one of a sound generation device. Type of the sound generation device may include, but not limited to, an acoustic device, an electronic device, and a hybrid device. Examples of the acoustic device are analog guitar, flute, drums, a membranophone percussion instrument, a violin and alike. Examples of the electronic device are electronic guitar, a synthesizer, an octapad, and a theremin. The hybrid devices are the analog devices coupled with an electronic music processor. It is to be noted that the sound generation device may create the audio signature in an analog format. In other words, the audio signature may be in a wave form.

In order to encode the audio signature, initially, the receiving module 234 receives the audio signal chain from at least one sound generation device. The receiving module 234 also receives a plurality of parameters about the at least one sound generation device. The plurality of parameters comprises at least one of manufacturer information, a device id, a device year, a serial number, seller information, a timestamp, and an assembly location. In one embodiment, the receiving module 234 may also receive a video signal. The system 102 may extract the audio signal from the video signal by using pre-processing techniques. The audio signal comprises one or more audio signal chains. In one embodiment, the audio signal, the audio signal chain and the plurality of the parameters may be stored at the system database 246.

Once, the audio signal and the plurality of the parameters are received, the generation module 236 generates a unique identification number based on the plurality of parameters. It is to be noted that the unique identification number is in digital format. Example of the unique identification number is “10DE95RXEB55445”, “10CF34AXSA12345”, “10RR423XGC00563” and alike. In an exemplary embodiment, “10DE95RXEB55445” comprises a AID version as “10”, manufacturer as “DE”, model number as “95R”, checksum as “X”, model year as “E”, the assembly location of the sound generation device as “B”, and the serial number as “55445”. In one embodiment, the unique identification number may be stored at the system database 246.

In order to encode the audio signal chain, the conversion module 238 converts the unique identification number into an audio signature having a frequency beyond a predefined threshold range. The predefined threshold range is a frequency range of human hearing. Typically, the frequency range of human hearing is between 20 Hz to 20 KHz. In one implementation, the audio signature may have the frequency amongst at least one of an ultrasonic frequency, a hypersonic frequency, a radio frequency. In another implementation, the audio signature may have the frequency in the range of 21 KHz to 100 KHz. In another implementation, the audio signature may have the frequency in the range of 1 Hz to 19 Hz. In another implementation, the audio signature may be converted at a fixed time, at periodical intervals, or at a random interval. In one embodiment, the audio signature may be stored at the system database 246.

Once the audio signature is generated, the encoding module 240 encodes the audio signal chain by embedding the audio signature into the audio signal chain. In one implementation, the encoding module 240 may overlap the audio signature and the audio signal to facilitate verification of the audio signal chain. In another implementation, the audio signature may be embedded at a regular interval of the audio signal. In another implementation, the encoding module 240 may be configured to embed one or more audio signatures corresponding to the one or more audio signals to create the audio signal chain. Thus, once the audio signal chain is encoded, the system 102 may identify at least one sound generation device upon listening to the audio signal chain. In one implementation, the system 102 and the system 102 may be a single system 102. In other words, the functionality of the both the system 102 and the system 102 may be replicated or implemented on the single system 102.

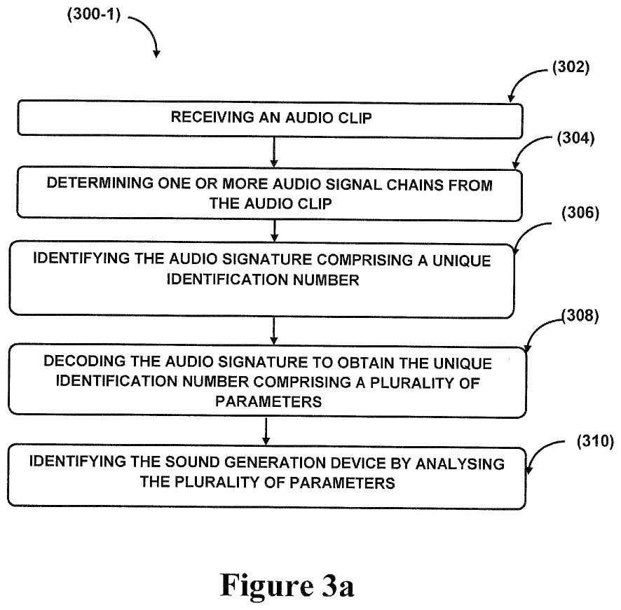

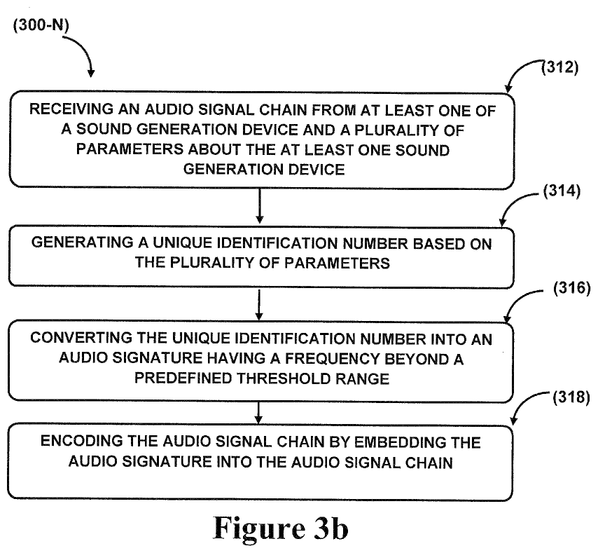

Referring now to FIG. 3a, a method 300-1 for identifying a sound generation device is shown, in accordance with an embodiment of the present subject matter. The method 300-1 may be described in the general context of computer executable instructions. Generally, computer executable instructions can include routines, programs, objects, components, data structures, procedures, modules, functions, etc., that perform particular functions or implement particular abstract data types. The method 300-1 may also be practiced in a distributed computing environment where functions are performed by remote processing devices that are linked through a communications network. In a distributed computing environment, computer executable instructions may be located in both local and remote computer storage media, including memory storage devices.

The order in which the method 300-1 for identifying a sound generation device is described is not intended to be construed as a limitation, and any number of the described method blocks can be combined in any order to implement the method 300-1 or alternate methods. Additionally, individual blocks may be deleted from the method 300-1 without departing from the spirit and scope of the subject matter described herein. Furthermore, the method 300-1 can be implemented in any suitable hardware, software, firmware, or combination thereof. However, for ease of explanation, in the embodiments described below, the method 300-1 may be considered to be implemented as described in the system 102.

At block 302, an audio clip may be received. In one implementation, the audio clip may be received by a receiving module 212 and stored at a system database 222.

At block 304, one or more audio signatures may be determined from the audio clip. In one aspect, each audio signature from the one or more audio signal chains correspond to at least one of a sound generation device. In another aspect, each audio signal chain comprises an audio signature having a frequency beyond a predefined threshold range. In one implementation, the one or more audio signatures may be determined by a determination module 214 and stored at the system database 222.

At block 306, the audio signature comprising a unique identification number may be identified. In one implementation, the audio signature may be identified by an identification module 216 and stored at the system database 222.

At block 308, the audio signature may be decoded to obtain the unique identification number comprising a plurality of parameters. In one implementation, the audio signature may be decoded by a decoding module 218 and stored at the system database 222.

At block 310, the sound generation device may be identified by analyzing the plurality of parameters. In one implementation, the sound generation device may be identified by an identification module 216 and stored at the system database 222.

Referring now to FIG. 3b, a method 300-N for encoding an audio signature is shown, in accordance with an embodiment of the present subject matter. The method 300-N may be described in the general context of computer executable instructions. Generally, computer executable instructions can include routines, programs, objects, components, data structures, procedures, modules, functions, etc., that perform particular functions or implement particular abstract data types. The method 300-N may also be practiced in a distributed computing environment where functions are performed by remote processing devices that are linked through a communications network. In a distributed computing environment, computer executable instructions may be located in both local and remote computer storage media, including memory storage devices.

The order in which the method 300-N for encoding an audio signature is described is not intended to be construed as a limitation, and any number of the described method blocks can be combined in any order to implement the method 300-N or alternate methods. Additionally, individual blocks may be deleted from the method 300-N without departing from the spirit and scope of the subject matter described herein. Furthermore, the method 300-N can be implemented in any suitable hardware, software, firmware, or combination thereof. However, for ease of explanation, in the embodiments described below, the method 300-N may be considered to be implemented as described in the system 102.

At block 312, an audio signature from at least one of a sound generation device and a plurality of parameters about the at least one sound generation device may be received. In one implementation, the audio signature and the plurality of parameters may be received by a receiving module 234 and stored at a system database 246.

At block 314, a unique identification number may be generated based on the plurality of parameters. In one implementation, the unique identification number may be generated by a generation module 236 and stored at the system database 246.

At block 316, the unique identification number may be converted into an audio signature having a frequency beyond a predefined threshold range. In one implementation, the unique identification number may be converted into the audio signature by a conversion module 238 and stored at the system database 246.

At block 318, the audio signature may be encoded by embedding into the audio signal chain. In one implementation, the audio signature may be encoded by an encoding module 240 and stored at the system database 246.

Exemplary embodiments discussed above may provide certain advantages. Though not required to practice aspects of the disclosure, these advantages may include those provided by the following features.

Some embodiments enable a system and a method to facilitate identification of the sound generation device in real time.

Some embodiments enable a system and a method to encode the audio signal chain using a high frequency audio signature.

Some embodiments enable a system and a method to verify authenticity of the audio signal chain and the sound generation device.

Some embodiments enable a system and a method to assess quality of the audio signal chain and the sound generation device used to create the audio clip.

Although implementations for methods and systems for identifying a sound generation device have been described in language specific to structural features and/or methods, it is to be understood that the appended claims are not necessarily limited to the specific features or methods described. Rather, the specific features and methods are disclosed as examples of implementations for identifying the sound generation device.

1. A method for identifying a sound generation device, the method comprising:
receiving, by a processor, an audio clip;
determining, by the processor, one or more audio signatures from the audio clip, wherein each audio signature from one or more audio signal chains correspond to at least one sound generation device, and wherein each of the one or more audio signal chain comprises an audio signature having a frequency beyond a predefined threshold range;
identifying, by the processor, the audio signature comprising a unique identification number;
decoding, by the processor, the audio signature to obtain the unique identification number comprising a plurality of parameters; and
identifying, by the processor, the sound generation device by analyzing the plurality of parameters.

2. The method of claim 1, wherein the sound generation device is at least one of: an acoustic device, an electronic device, and a hybrid device.

3. The method of claim 1, wherein the plurality of parameters comprises at least one of manufacturer information, a device ID, a device year, a serial number, seller information, a timestamp, and an assembly location.

4. A method for encoding an audio signal chain, the method comprising:
receiving, by a processor, an audio signal chain from at least one sound generation device and a plurality of parameters about the at least one sound generation device;
generating, by the processor, a unique identification number based on the plurality of parameters;
converting, by the processor, the unique identification number into an audio signature having a frequency beyond a predefined threshold range; and
encoding, by the processor, the audio signal chain by embedding the audio signature into the audio signal chain.

5. The method of claim 4, wherein the at least one sound generation device is at least one of: an acoustic device, an electronic device, and a hybrid device.

6. The method of claim 4, wherein the plurality of parameters comprises at least one of manufacturer information, a device ID, a device year, a serial number, seller information, a timestamp, and an assembly location.

7. A system for identifying a sound generation device, the system comprising:
a processor; and
a memory coupled to the processor, wherein the processor executes a set of instructions stored in the memory for:
receiving an audio clip;
determining one or more audio signatures from the audio clip, wherein each audio signature from one or more audio signal chains correspond to at least one sound generation device, and wherein each of the one or more audio signal chain comprises an audio signature having a frequency beyond a predefined threshold range;
identifying the audio signature comprising a unique identification number;
decoding the audio signature to obtain the unique identification number comprising a plurality of parameters; and
identifying the sound generation device by analyzing the plurality of parameters.

8. The system of claim 7, wherein the sound generation device is at least one of: an acoustic device, an electronic device, and a hybrid device.

9. The system of claim 7, wherein the plurality of parameters comprises at least one of: manufacturer information, a device ID, a device year, serial number, seller information, a timestamp, and an assembly location.

10. A system for encoding an audio signal chain, the system comprising:
a processor; and
a memory coupled to the processor, wherein the processor executes a set of instructions stored in the memory for:
receiving an audio signal chain from at least one sound generation device and a plurality of parameters about the at least one sound generation device;
generating a unique identification number based on the plurality of parameters;
converting the unique identification number into an audio signature having a frequency beyond a predefined threshold range; and
encoding the audio signal chain by embedding the audio signature into the audio signal chain.

11. The system of claim 10, wherein the at least one sound generation device is at least one of: an acoustic device, an electronic device, and a hybrid device.

12. The system of claim 10, wherein the plurality of parameters comprises at least one of:
manufacturer information, a device ID, a device year, serial number, seller information, a timestamp, and an assembly location.

13. A non-transitory computer readable medium embodying a program executable in a computing device for identifying a sound generation device, the program comprising:
a program code for receiving an audio signal chain from at least one sound generation device and a plurality of parameters about the at least one sound generation device;
a program code for generating a unique identification number based on the plurality of parameters;
a program code for converting the unique identification number into an audio signature having a frequency beyond a predefined threshold range;
a program code for encoding the audio signal chain by embedding the audio signature into the audio signal chain;
a program code for receiving an audio clip comprising one or more audio signal chains;
a program code for determining the one or more audio signatures, wherein each audio signature from the one or more audio signal chains correspond to at least one sound generation device;
a program code for identifying the audio signature comprising the unique identification number;
a program code for decoding the audio signature to obtain the unique identification number comprising the plurality of parameters; and
a program code for identifying the sound generation device by analyzing the plurality of parameters.
